(19) United States
(12) Patent Application Publication
(10) Pub. No.: US 2026/0119933 A1
(43) Pub. Date: Apr. 30, 2026

(54) QUBO DATA IMPUTATION BY DENOISING DIFFUSION PROBABILISTIC MODELS

(71) Applicant: Dell Products L.P., Round Rock, TX (US)

(72) Inventors: Ítalo Gomes Santana, Rio de Janeiro (BR); Diego Vrague Noble, Pelotas (BR); Miguel Paredes Quiñones, Campinas (BR)

(21) Appl. No.: 18/927,005

(22) Filed: Oct. 25, 2024

(51) Int. Cl. G06N 10/20; G06N 10/40

(52) U.S. Cl. CPC G06N 10/20; G06N 10/40

(57) ABSTRACT

One example method includes receiving a Quadratic Unconstrained Binary Optimization (QUBO) problem that comprises a matrix that includes various cells having data. It is then determined that one or more of cells is missing data or has corrupted data. A machine learning (ML) model performs a denoising process that removes random noise from the one or more cells having the missing data or corrupted data. This results in data being imputed to the one or more cells having the missing data or the corrupted data. The imputed data approximates the missing data or approximates an expected value of the corrupted data before the corrupted data was corrupted.

### TECHNOLOGICAL FIELD OF THE DISCLOSURE

One or more embodiments disclosed herein generally relate to resolution of Quadratic Unconstrained Binary Optimization (QUBO) problems. More particularly, at least some embodiments relate to systems, hardware, software, computer-readable media, and methods, for using a machine-learning model to impute data to cells of a QUBO matrix that have missing or corrupted data.

### BACKGROUND

Data imputation (DI) techniques are well-studied subjects in the scientific literature and largely applied and tested on real-life use cases. Their main purpose is to replace missing data with new data that will approximate the original content. Traditional DI techniques may employ statistical analysis, machine learning models or simple arithmetic calculations (e.g., mean of neighbors) to determine the new data.

Traditional DI techniques, however, do not often work well for QUBO problems. Specifically, these traditional DI techniques usually employ local and/or greedy procedures to impute data, whereas capturing the QUBO problem's structure is crucial for correctly imputing missing data. Moreover, the number of missing cells can be multiple, making the imputation quality crucial in determining an accurate matrix of coefficients of a QUBO problem.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIGS. 1A and 1B disclose aspects of upper triangular, and hashtable, representations of a QUBO and QUBO patterns.

FIG. 2 discloses aspects of a QUBO generation process for the so-called Traveling Salesperson Problem (TSP).

FIGS. 3A-3B disclose aspects of training a machine learning (ML) model.

FIGS. 4A-4D disclose aspects of using the trained ML model.

FIG. 5 discloses aspects of a method according to one embodiment.

FIG. 6 discloses a computing entity configured and operable to perform any of the disclosed methods, processes, and operations.

### DETAILED DESCRIPTION OF SOME EXAMPLE EMBODIMENTS

One or more embodiments disclosed herein generally relate to resolution of Quadratic Unconstrained Binary Optimization (QUBO) problems. More particularly, at least some embodiments relate to systems, hardware, software, computer-readable media, and methods, for using a machine-learning model to impute data to cells of a QUBO matrix that have missing or corrupted data.

One example method includes receiving a Quadratic Unconstrained Binary Optimization (QUBO) problem that comprises a matrix that includes various cells having data. It is then determined that one or more of cells is missing data or has corrupted data. A machine learning (ML) model performs a denoising process that removes random noise from the one or more cells having the missing data or corrupted data. This results in data being imputed to the one or more cells having the missing data or the corrupted data. The imputed data approximates the missing data or approximates an expected value of the corrupted data before the corrupted data was corrupted.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

### A. Context for an Example Embodiment

The following is a discussion of aspects of a context for various embodiments. This discussion is not intended to limit the scope of the claims or this disclosure, or the applicability of the embodiments, in any way.

The embodiments disclosed herein implement one or more machine learning (ML) models. As used herein, reference to any type of machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

Combinatorial optimization (CO) problems belong to a class of problems which aims at finding the best possible solution among a finite but extensive set of possible solutions. This set is usually exponential in size, making efforts in developing advanced algorithmic strategies even more crucial, especially when these problems are large and arise in real-world scenarios, that is, intricate configurations. QA is an emerging technique that leverages quantum effects, such as entanglement and tunneling, to accelerate the solving process of CO problems. When QAs are prohibitive, alternatives to QA, such as the Simulated QA (SQA) or Simulated Annealing (SA), can also be successful to solve CO problems in classical hardware.

For any of these CO solvers, it has been useful to solve these problems after they have been modelled into a mathematical format called Quadratic Unconstrained Binary Optimization (QUBO) or, in short, QUBO problems, or simply QUBOs. Problems in this format are first defined into a single Hamiltonian function that contains the objective function and constraints, therefore, avoiding the explicit definition of constraints as usually expressed in traditional formats as Mixed-Integer Linear Programming (MILP). After the definition of the Hamiltonian function, the input data is processed in a method called compilation to derive a nxn QUBO matrix, where n is the number of binary variables of the QUBO. In the QUBO matrix, each cell consists of a rational number as coefficient for each pair of binary variables, namely, one variable for the row and another variable for the column. An embodiment may leverage this simple notation to enable CO problems generated by resource-constrained devices to be solved into a robust machine, such as quantum or classical computing machine for example.

As used herein, the word QUBO can have two meanings depending on the context: (1) a QUBO is an abstract form that represents a form of encoding an optimization problem in the specific format described elsewhere herein; and (2) a QUBO problem instance or QUBO matrix is a concrete form, or instance, of an optimization problem encoded as a QUBO—this concrete form may be understood as a final stage before the problem is solved—in this stage, all coefficients and variables are defined. It is noted that both QUBOs and Ising models are equivalent through a polynomial transformation therefore an embodiment may adopt only the QUBO representation, for the sake of brevity.

### A.1 QUBOs

In the modeling of an optimization problem as a QUBO, an embodiment may have a pseudo-Boolean function ƒ: {0,1}ⁿ [symbol] [symbol] such that the aim is to find one attribution x ∈ {0,1}ⁿ of binary values that minimizes the value of ƒ, that is, min_{x∈{0,1}}_{ⁿ} ƒ(x). The function ƒ is of degree at most two, and is usually defined as a summation of linear and quadratic terms in the form:

$$\begin{matrix}Equation 1 - QUBO general form & \\ f ( {x}_{1} , … , {x}_{n} ) = {c}_{0} + {\sum }_{j = 1}^{n} {c}_{j} {x}_{j} + {\sum }_{i = 1}^{n} {\sum }_{j = i + 1}^{n} {c}_{i j} {x}_{i} {x}_{j} & \end{matrix}$$

In this form, c₀ is called the offset while the cᵢ for i=1, . . . , n terms are called linear terms and the cᵢⱼ for 1≤i<j≤n terms are called the quadratic terms. Each input—that is, each variable assignment for all variables—to this function has a corresponding energy value, thus the QUBO optimization problem can be expressed alternatively as min_{xE{0,1}}_{ⁿ}xQx^{T} such that Q ∈ [symbol] ^{{n×n}}. The symmetric matrix Q is usually referred to itself as the QUBO.

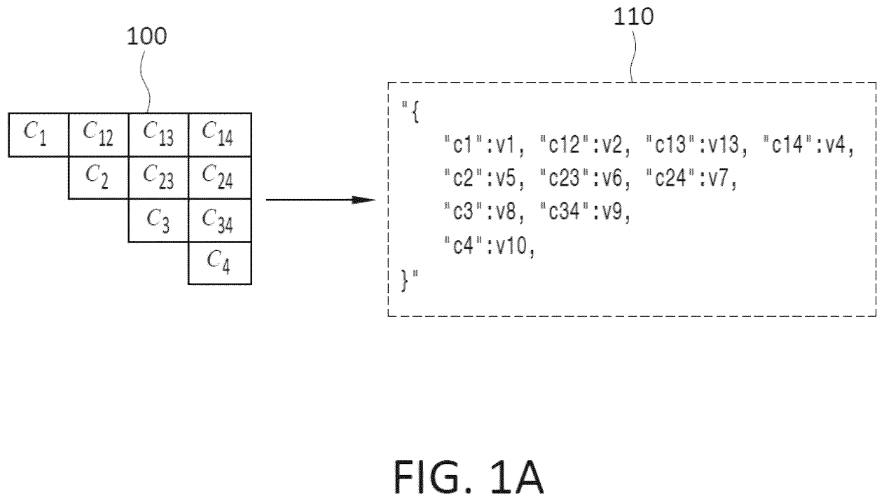

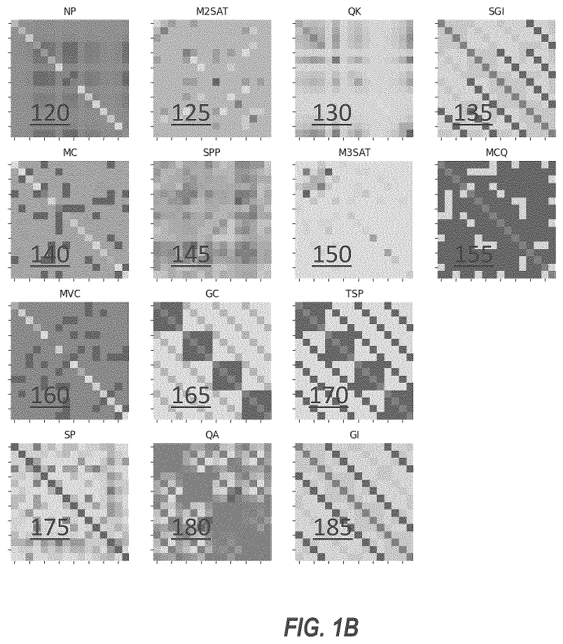

When modelling problems using the QUBO format, there are two commonly used representations: the symmetric matrix or the upper triangular matrix. The upper triangular matrix representation is preferred when one seeks to avoid transmitting or storing redundant information while the symmetric matrix representation is preferred when solving or manipulating the QUBO itself. An example of an upper triangular matrix 100 is depicted in FIG. 1A. This representation can also be transformed into a hashtable, or dictionary, such as the example hashtable 110 depicted in FIG. 1A. In particular, the upper triangular matrix 100 and hashtable 110 are forms of representing a QUBO and are interchangeable. The placeholders v1, v2, . . . v10 represent the floating-point coefficient values themselves.

The value of each coefficient is a floating point that depends on how the input instance of the problem and the problem's objective function was translated into the QUBO format. The first step is to produce a valid mathematical representation of problem's objective function and constraints that can be converted to Equation 1.

Another aspect of QUBOs is that different patterns can be seen in the QUBO matrix associated with different optimization problems. These different patterns are inherited from the optimization problem's structure itself. Thus, each instance of a QUBO may resemble similar instances of the same problem or even similar derived problems.

FIG. 1B illustrates the richness of patterns that different optimization problems can have when translated into QUBOs. For example, the QUBO matrix associated with number partitioning (NP) optimization problem is shown at 120. The QUBO matrix associated with the number partitioning (NP) optimization problem is shown at 120. The QUBO matrix associated with the Max2Sat (M2SAT) optimization problem is shown at 125. The QUBO matrix associated with the Quadratic Knapsack (QK) optimization problem is shown at 130. The QUBO matrix associated with the Subgraph Isomorphism (SI) optimization problem is shown at 135. The QUBO matrix associated with the MaxCut (MC) optimization problem is shown at 140. The QUBO matrix associated with the Set Partitioning (SPP) optimization problem is shown at 145. The QUBO matrix associated with the Max3SAT (M3SAT) optimization problem is shown at 150. The QUBO matrix associated with the Maximum Clique (MCQ) optimization problem is shown at 155. The QUBO matrix associated with the Minimum Vertex Cover (MVC) optimization problem is shown at 160. The QUBO matrix associated with the Graph Coloring (GC) optimization problem is shown at 165. The QUBO matrix associated with the Traveling Salesperson Problem (TSP) optimization problem is shown at 170. The QUBO matrix associated with the Set Packing (SP) optimization problem is shown at 175. The QUBO matrix associated with the Quadratic Assignment optimization problem is shown at 180. The QUBO matrix associated with the Graph Isomorphism (GI) optimization problem is shown at 185. As can be seen from FIG. 1B, different optimization problems may have similar patterns even though they are different, such as Graph Coloring (GC) 165 and Traveling Salesperson Problem (TSP) 170.

### A.2 Quantum Annealing

With this mathematical representation, a process called compilation is executed to combine the mathematical definition along with the problem's instance input to produce a QUBO upper, or lower, triangular matrix or symmetric matrix. Next, a quantum annealer, or a simulated quantum annealer, may use this upper triangular matrix to find the variable assignment x that minimizes the energy of that QUBO. The mathematical representation is constant for a given problem configuration.

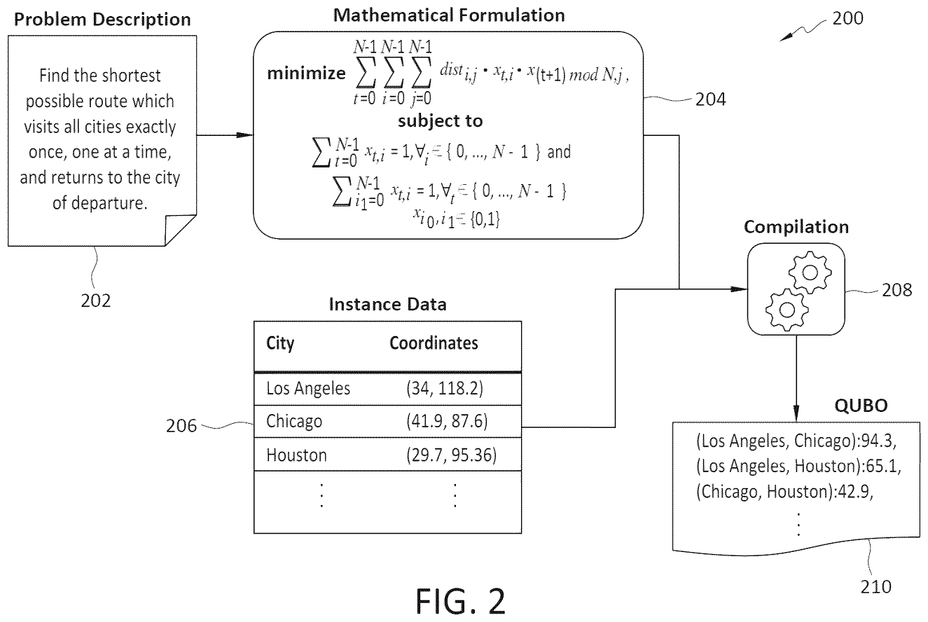

FIG. 2 illustrates this whole process, denoted at 200, using the Traveling Salesperson Problem (TSP) 170, which is a combinatorial optimization problem that can be modeled as QUBO. An initial problem description 202 is given, resulting into a valid mathematical formulation 204 for TSP. Next, the instance input, or instance data 206, for the problem is also given and compiled using the valid mathematical formulation to generate a compilation 208, therefore, producing an upper triangular matrix. A solution 210 to the QUBO may then be generated using the compilation 208. It is noted with respect to the example of FIG. 2, each set of instance data 206 must compile independently so as to generate a respective new QUBO. The values in FIG. 2 are placeholders only and variable names used were city names.

Solving an arbitrary QUBO, that is, finding a global minimum in an energy function, is an NP-hard problem, which is a class of problems that is not known to be solvable by exact methods in polynomial time on deterministic machines such as in classical computers. QUBOs can be solved heuristically using quantum annealing, a technique that leverages quantum phenomena such as quantum entanglement and quantum tunneling to explore the space of possible assignments more effectively in a specialized hardware.

### B. Overview of Aspects of One or More Embodiments

### B.1 Introduction

As discussed above, each QUBO problem has a QUBO matrix. However, in some instances, there are scenarios where a QUBO problem has some matrix cells that having missing data and/or has matrix cells that have corrupted data. For instance, in one scenario there is a set of hardware-limited devices such as drones and a central node to process every solution request sent by these devices. In this example, each device yields a QUBO problem (e.g., path-planning) to perform a high-priority task, sends this problem to the central node, and waits for a solution. Due to existing interferences in the air (e.g., environment, multiple signal sources, solids, etc.) some matrix cells from the problem are missing data or have corrupted data at the central node and, due to the urgency in solving this problem, the central node must impute data for the missing or corrupted data to solve the QUBO problem. Another application relies on QUBO retrieval from data storages, where hardware failures may corrupt some matrix cells, making needed a procedure to detect inconsistency in data and its posterior imputation.

Accordingly, the embodiments provide for a way to impute data to the missing and/or corrupted cells. In the embodiments, a machine learning (ML) model, such as a Denoising Diffusion Probabilistic Model (DDPM), is used impute the missing and/or corrupted data to the matrix cells. That is, the ML model determines an approximation of what the missing and/or corrupted data should have been, then imputes this data to the relevant matrix cells so that the QUBO problem can be solved. It will be appreciated that while the imputed data may not be exactly the same, it will be close enough for the QUBO problem to be solved in an acceptable manner. In other words, the reconstructed QUBO problem that has the imputed data should be as close as possible to the original QUBO problem so that the resulting solution is an acceptable alternative to the originally intended solution. For example, in the path-planning scenario involving the drones discussed previously, the solution to the reconstructed QUBO problem might cause the drone to make an anticipated 180 degree turnaround in a manner different from, but still close to, what the solution to the original QUBO problem would be, for example having the drone begin the turnaround by turning left rather than right. Accordingly, the embodiments disclosed herein minimize approximate error during the data imputation to help ensure that reconstructed QUBO problem that has the imputed data is as close as possible to the original QUBO problem.

### B.2 Training

In this phase, a single DDPM is trained in a way that it that learns to denoise specific QUBOs coming from a type of optimization problem and its minor embedding to a target architecture/device. To do so, a noise model, which is part of the DDPM used during the training phase, first adds noise to a transmitted QUBO, for example, a communication channel in which the embodiments will be deployed. The noise level should represent how much the QUBO matrix will be impacted in terms of intensity and number of cells when noise is applied. Thus, each training instance of the training dataset to the DDPM may consists of a pair of QUBOs (before and after the transmission) from different problem instances of the same problem type. The final dataset is, therefore, composed of QUBOs from multiple problem types and minor embedded to different devices.

The training of a typical DDPM for denoising images consists of considering one input as the original image with a controlled application of the noise on it. The DDPM learns this modification and applies again successive rounds of noises on each resulting image until a termination criterion is reached (e.g., all image data approximates to a random distribution). In other words, a noise function is applied on x₀ (input image) successively until reaches x_{T}, where T is predefined. Afterwards, the training strategy is inverted by denoising each xᵢ, where i ∈ {1, . . . , T} to compute the loss function between all xᵢ₋₁ and xᵢ₋₁, where xᵢ₋₁ is the predecessor of xᵢ (i.e., before applying the noise) and \hat{x}ᵢ₋₁ is the denoised image for xᵢ. Thus, allowing the DDPM in self-correcting its denoising process over the input probability distribution. Overall, the burden for training any DDPM is computationally intensive, since T is usually a large number and each application of a noising/denoising step should be small as possible due to the sensitiveness in the error propagation.

The embodiments disclosed herein follow the training process previously described with the addition of a guiding term specifically designed for QUBOs. First, the equivalence between single-channel images (e.g., grayscale) and QUBOs is established due to the QUBOs representations in matrices of coefficients, making the traditional training of DDPMs equivalent for QUBOs (i.e., x₀=Q₀).

However, different from the usual DDPM training, the model of the embodiments disclosed herein presents a guided process for denoising QUBOs by a generic term called “Guide”. This guiding factor restricts the denoising of any QUBO Qᵢ subjected to, for example, the features of the optimization problem and the architecture of quantum annealer in which this problem will be solved. More specifically, features of the optimization problem consist of the problem's constraints and objective function, number of variables/qubits or any other term that defines the optimization problem. As a result, the denoising will impute data iteratively, accounting to the learned distribution, global problem's structure (e.g., looking for patterns matrix cells that are present that could guess the best approximative value over the current imputation).

Another constraint in the guiding process in the embodiments disclosed herein is the target QA architecture in which the problem will be solved. It is noted that solving QUBOs on real quantum annealers requires solving the minor embedding problem, which maps the QUBO variables and its connections to the topology of qubits of the annealer which are not fully connected. The denoising process can, for example, impute the best approximate data considering the annealer topology in which this QUBO will be solved. In the drone-server example discussed previously, the server has the annealer details, making it possible to share all needed information (e.g., number of qubits, qubit connectivity, coherence, etc.) to the denoising process. As a result, for both the QUBO problem features and the QA architecture, the noise model, at each data imputation, is able to deal with multiple constraints to return a single value. As a result, this implies that the richer is the number of guiding constraints, the higher is the quality of the imputed data (i.e., accuracy) or faster is its data generation.

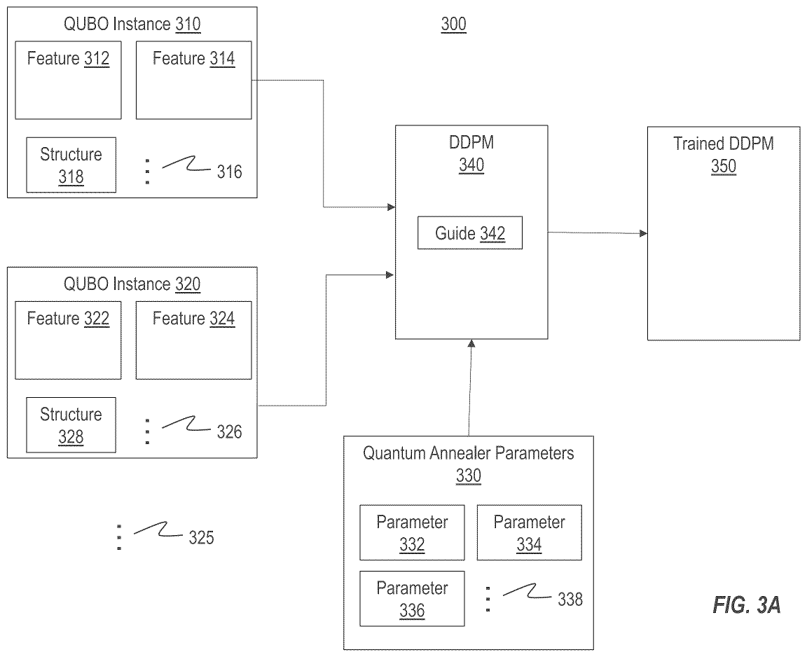

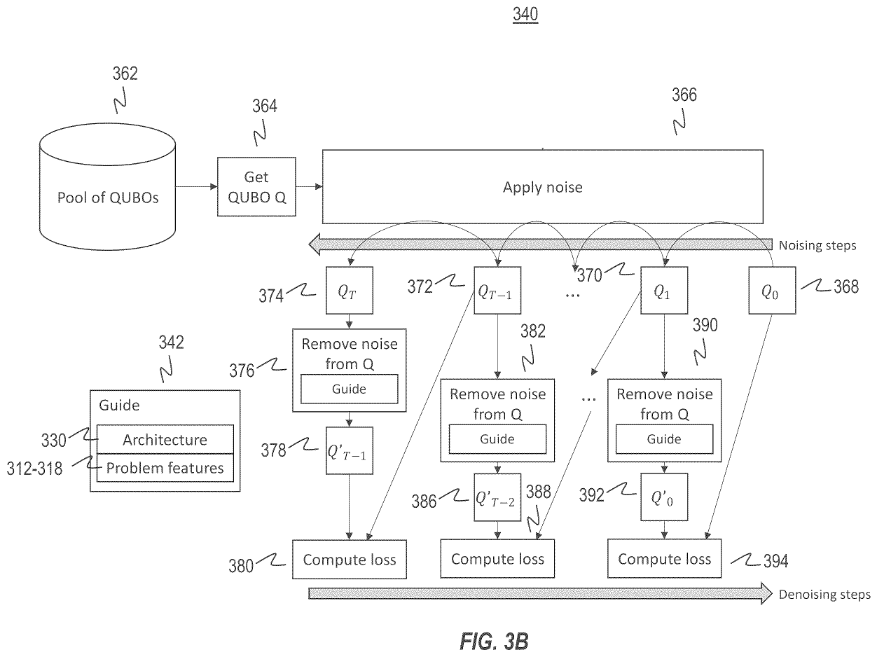

A specific example of the training process will now be described in FIGS. 3A-3B, which illustrate an environment 300 where the embodiments disclosed herein may be practiced. In particular, the environment 300 is used to train a DDPM ML model that can then be used to impute data to a QUBO problem matrix.

As illustrated in FIG. 3A, the environment 300 includes a QUBO instance 310, a QUBO instance 320, and any number of additional QUBO instances 325 as illustrated by the ellipses. As further illustrated, each of the QUBO instances includes various problem features (or at least metadata about their features) that are specific to the problem type of the QUBO. For example, the TSP QUBO problem 170 would have features that are specific tot this type of QUBO that are different from the other types of QUBO problems, which in turn would have their own respective features. As illustrated, the QUBO instance 310 includes a feature 312, a feature 314, and any number of additional features 316 as illustrated by the ellipses. In one embodiment, the features 312, 314, and 316 may include, but are not limited to, QUBO size, QUBO problem difficulty, QUBO coefficient interdependency, QUBO variable connectivity, and number of variables or qubits.

The QUBO instance 310 also includes a structure feature 318 that defines a structure of the QUBO based on the QUBO problem type. For example, if the QUBO instance 310 was a Max3SAT optimization problem as shown at 150, it would have one type of structure feature 318 and if it were the Traveling Salesperson Problem (TSP) optimization problem as shown at 170 it would have another structure feature 318. Thus, the structure feature 318 will be different for each of the QUBO patterns 120-185 discussed previously.

Likewise, the QUBO instance 320 includes a feature 322, a feature 324, and any number of additional features 326 as illustrated by the ellipses that correspond to the features 312, 314, and 316. The QUBO instance 320 also includes a structure feature 328 that defines a structure of the QUBO based on the QUBO problem type. Thus, the structure feature 328 will be different for each of the QUBO patterns 120-185 discussed previously. Although not illustrated, any of the additional QUBO instances 325 would also have features and a structure feature.

The environment 300 also includes quantum annealer parameters 330 that are related to the architecture of the QA that will be used to solve the QUBO problem. For example, the QA parameters 330 may include a QA parameter 332, a QA parameter 334, a QA parameter 336, and any number of additional QA parameters 338 as illustrated by the ellipses. In one embodiment, the QA parameters 332, 334, and 336 may include, but are not limited to, QA topology, number of qubits, and quality of the qubits.

The environment 300 also includes a ML model 340, which may be a DDPM 340. In operation, the DDPM receives one of the QUBO instances, such as QUBO instance 310, in a process that adds noise to the QUBO instance 310 to remove or corrupt the data in one or more cells of the QUBO matrix and then denoises the QUBO instance 310 by using its features along with the QA parameters 330, which are considered a guide 342, to restore a close approximation of the data in the one or more cells of the QUBO matrix as will be explained in more detail to follow. This process results in a trained ML model 350, such as a trained DDPM 350 that can then be used in an inference operation as will be explained in more detail to follow.

FIG. 3B illustrates an embodiment of the DDPM 340 and its operation. As illustrated in FIG. 3B, the model receives or otherwise accesses 364 a QUBO Q, such as QUBO 310, from a pool of QUBOs 362. The DDPM 340 then applies noise 366 to the QUBO Q in series of steps to thereby remove and/or corrupt data in one or more of the cells QUBO matrix of QUBO Q. For example, at 368 some noise is applied to QUBO Q (referred to as QUBO Q₀) to thereby generate a QUBO Q₁. At 370, noise is added to the QUBO Q₁ to thereby generate a modified QUBO. This process continues until as shown at 372, noise is added to a QUBO Q_{T-1} to thereby generate a QUBO Q_{T} as shown at 374, where the process of adding noise ends. It will be noted that the process of adding noise is performed until a predetermined termination criterion is reached, where the predetermined termination criterion is typically based on the QUBO problem type. In one embodiment, the predetermined termination criterion may be reached when all the data that has been corrupted in the QUBO matrix approximates a random distribution. In another embodiment, the predetermined termination criterion may be set to a specific number of noising steps such as performing 1000 noising steps.

Once the noise has been added to remove and/or corrupt the data in the one or more cells of the QUBO matrix, the DDPM 340 is then trained to remove the noise to thereby impute data to replace the missing and/or corrupted data. Thus, at 376 some of the noise is removed from QUBO Q_{T} using the guide 342 with its corresponding QA parameters 330 and features 312-318 to add constraints to the denoising process as previously described, resulting in a QUBO Q′_{T-1} as shown at 378. The QUBO matrix of QUBO Q′_{T-1} shown at 378 and the QUBO matrix of QUBO Q_{T-1} shown at 372 are then compared with each other at 380 to compute a loss or difference between the two QUBO matrices, where a large difference indicates that the two QUBO matrices are not close as more noise still needs to be removed, and a small difference indicates that the two QUBO matrices are closer as less noise still needs to be removed. Thus, the loss calculation teaches the DDPM 340 to apply better computations to remove the noise.

At 382, some of the noise is removed from QUBO Q_{T-1} using the guide 342 with its corresponding QA parameters 330 and features 312-318 to add constraints to the denoising process as previously described and using the learning gained from removing noise from QUBO Q_{T}, resulting in a QUBO Q′_{T-2} as shown at 386. At 388, the QUBO matrix of QUBO Q′_{T-2} is then compared with the QUBO matrix of an earlier QUBO to compute a loss or difference between the two QUBO matrices as shown at 388. This process continues as illustrated by the ellipses until some of the noise is removed from QUBO Q₁ as shown at 390 using the guide 342 with its corresponding QA parameters 330 and features 312-318 to add constraints to the denoising process as previously described and using the learning gained from removing noise in the previous steps, resulting in a QUBO Q′₀ as shown at 392. The QUBO matrix of QUBO Q′₀ and the QUBO matrix of QUBO Q₀ are then compared with each other at 394 to compute a loss or difference between the two QUBO matrices. Once the denoising steps are completed, the training process should also be completed. That is, the DDPM 340 is now able to provide an acceptable approximation of the data missing and/or corrupted in a QUBO matrix as will be explained in more detail to follow.

### B.3 Inference

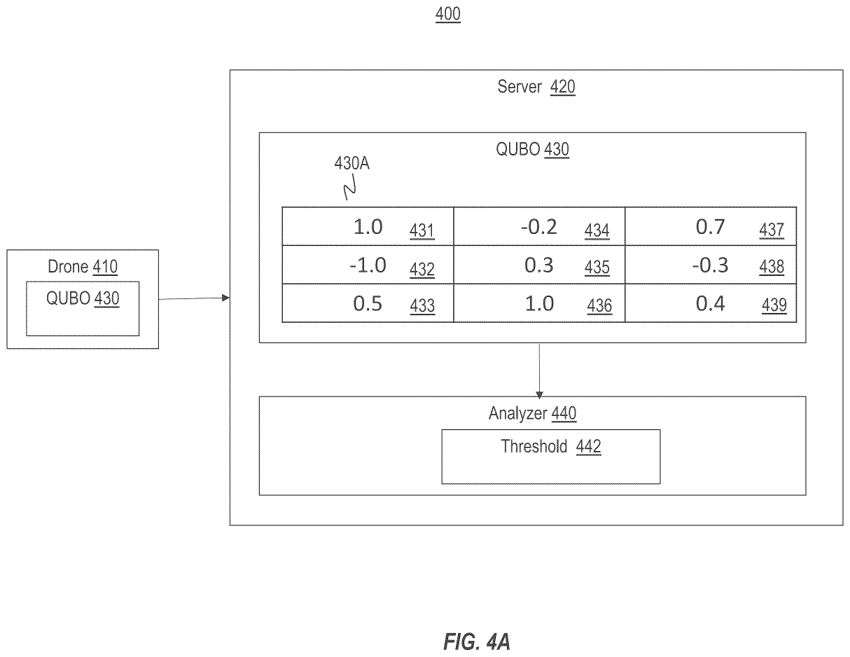

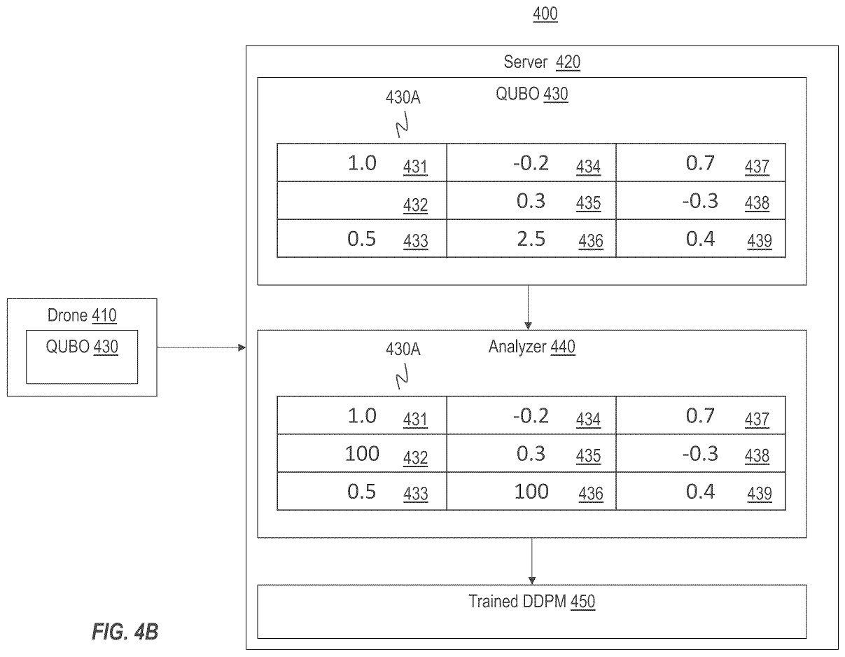

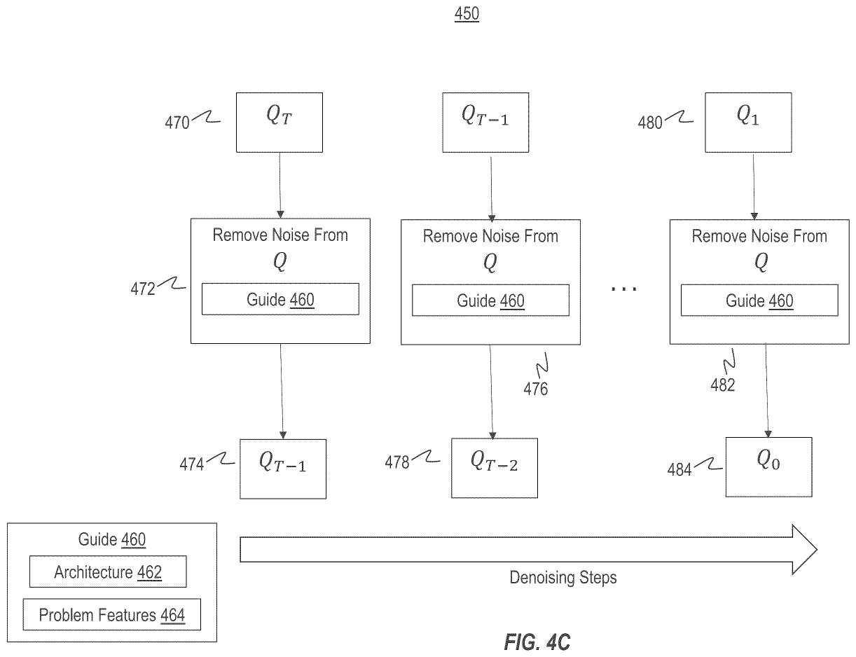

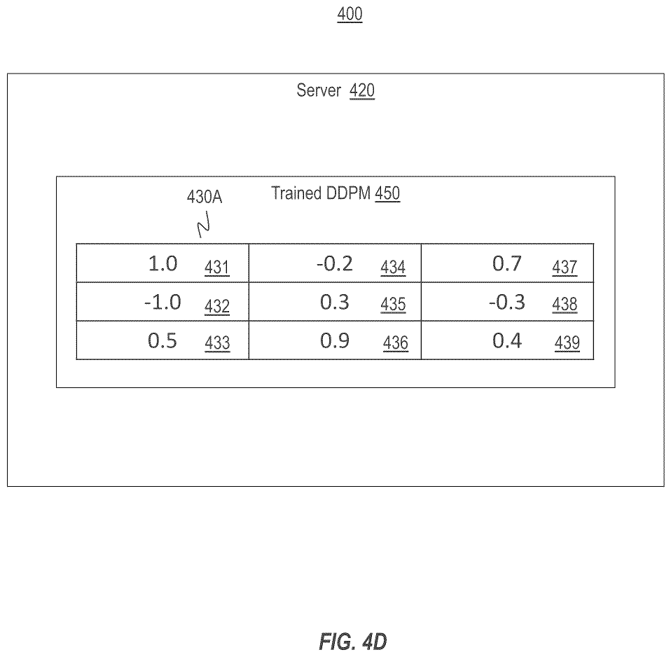

FIG. 4A illustrates an environment 400 where the embodiments disclosed herein may be practiced. In particular, in the environment 400 a trained DDPM ML model is used to impute data to a QUBO problem matrix.

As illustrated, the environment 400 includes a drone 410 and a central server 420. In operation, the drone 410 is a hardware-limited device and so the central server 420 processes every solution request sent by the drone 410. Thus, the drone 410 generates a QUBO problem 430, for example a path-planning problem, sends the QUBO problem to the central server, and waits for a solution.

In the embodiment, the QUBO 430 is shown as comprising a simplified symmetric matrix 430A that includes a cells 431-439. It will be appreciated, however, that in practice the QUBO matrix 430A would include numerous cells. In the embodiment, the data in the cells have been scaled to have value within the interval [−1.0,1.0]. Thus, the cell 431 has data value of 1.0, the cell 432 has a data value of 432, the cell 433 has a data value of 0.5, the cell 434 has a data value of −0.2, the cell 435 has a data value of 0.3, the cell 436 has a data value of 1.0, the cell 437 has a data value of 0.7, the cell 438 has a data value of −0.3, and cell 439 has a data value of 0.4.

The central server includes or otherwise has access to an analyzer 440. In operation, the analyzer 440 accesses a threshold 442 and determines if any of the cells 431-439 include missing data and/or corrupted data. In the embodiment, the threshold 442 is set to be the interval [−1.0,1.0] and so the analyze determines that QUBO 430 does not include any cells with missing or corrupted data. In such case, the central server is able to solve the QUBO 430 and provide the needed path-planning solution to the drone 410.

FIG. 4B illustrates another embodiment of the environment 400. In the embodiment of FIG. 4B, the drone 410 again generates a QUBO problem 430, sends the QUBO problem to the central server, and waits for a solution. However, in the embodiment of FIG. 4B, the cell 432 is missing data and the cell 436 is shown as having a data value of 2.5.

The analyzer 440 accesses the threshold 442 and determines if any of the cells 431-439 include missing data and/or corrupted data. In the embodiment, the threshold 442 is set to be the interval [−1.0,1.0] and so the analyzer 440 will determine that the cell 432 is missing data and that the data in the cell 436 is corrupted, since the data value of 2.5 is outside of the interval [−1.0,1.0], thus indicating that the data in the cell 436 has been corrupted.

The analyzer 440 then replaces the missing and/or corrupted data in the cells 432 and 436 with random noise that is far from any expected data value that could have existed in the cells. For example, as illustrated, the missing and/or corrupted data in the cells 432 and 436 are replaced with random noise having a data value of 100. Since the data in the cells 432 and 436 would be expected to have a data value between the interval [−1.0,1.0], a data value of 100 is far from any expected value.

The QUBO matrix having the random noise is then provided to a trained DDPM 450, which may correspond to DDPM 340 and 350 previously discussed. The trained DDPM 450 then begins a denoising process to remove the random noise placed in the cells 432 and 436 to thereby impute an acceptable approximation of the expected data in these cells as illustrated in FIG. 4C.

As illustrated in FIG. 4C, the trained DDPM 450 uses a guide 460, which may correspond to and operate in the same manner as the guide 342. In the embodiment, the guide 460 includes QA parameters 462 that correspond to the QA parameters 330 and that define an architecture of the QA that will solve the QUBO 430, and problem features 464 of the QUBO 430 that correspond to the problem features 312-318 and 322-328.

FIG. 4C shows at 470 that a QUBO Q_{T}, which corresponds to the QUBO 430 having the random noise in cells 432 and 436, will be subjected to denoising by the trained DDPM 450. At 472 some of the noise is removed from QUBO Q_{T} using the guide 460 with its corresponding QA parameters 462 and features 464 to add constraints to the denoising process as previously described, resulting in a QUBO Q_{T-1} as shown at 474. Since the trained DDPM 450 will have been previously trained to remove random noise in the manner described in relation to DDPM 340, there is no need to compute a loss or difference in the inference phase.

At 476, some of the noise is removed from QUBO Q_{T-1} using the guide 460 with its corresponding QA parameters 462 and features 464 to add constraints to the denoising process as previously described, resulting in a QUBO Q_{T-2} as shown at 478. This process continues as illustrated by the ellipses until reaching a QUBO Q₁ shown 480, where at 482 some of the noise is removed from QUBO Q₁ using the guide 460 with its corresponding QA parameters 462 and features 464 to add constraints to the denoising process as previously described, resulting in a QUBO Q₀ as shown at 484.

The QUBO Q₀ represents the QUBO 430 that has had the data in the cells 432 and 436 restored to an acceptable approximation of the original data. This is shown in FIG. 4D, which illustrates the updated QUBO 430 that has been subjected to the denoising operation of the trained DDPM 450. As shown, the cell 432 now has a data value of −1.0, which when compared to FIG. 4A is the original data value, thus showing that for cell 432 the data was completely restored. The cell 436 now has a data value of 0.9. In FIG. 4A, the original data value was 1.0, thus showing that for cell 436, although the original data value was not restored, an acceptable approximation of 0.9 was restored. The central server is then able to solve the updated QUBO 430 and provide the needed path-planning solution to the drone 410.

### C. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other byway of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

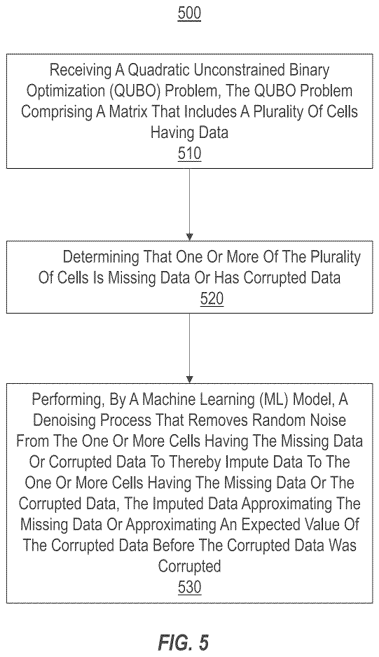

Directing attention now to FIG. 5, an example method 500 is disclosed. The method 500 will be described in relation to one or more of the figures previously described, although the method 500 is not limited to any particular embodiment.

The method 500 includes receiving a Quadratic Unconstrained Binary Optimization (QUBO) problem, the QUBO problem comprising a matrix that includes a plurality of cells having data (510). For example, as previously described the QUBO 430 that comprises the QUBO matrix 430A having the cells 431-439 is received.

The method 500 includes determining that one or more of the plurality of cells is missing data or has corrupted data (520). For example, as previously described the analyzer 440 determines that the cell 432 is missing data and that the cell 436 has corrupted data.

The method 500 includes performing, by a machine learning (ML) model, a denoising process that removes random noise from the one or more cells having the missing data or corrupted data to thereby impute data to the one or more cells having the missing data or the corrupted data, the imputed data approximating the missing data or approximating an expected value of the corrupted data before the corrupted data was corrupted (530). For example, as previously described the trained DDPM 450 performs the denoising process and imputes the data to the cells 432 and 436.

### D. Further Example Embodiments

Following are some further example embodiments. These are presented only by way of example and are not intended to limit the scope of this disclosure or the claims in any way.

Embodiment 1. A method, comprising: receiving a Quadratic Unconstrained Binary Optimization (QUBO) problem, the QUBO problem comprising a matrix that includes a plurality of cells having data; determining that one or more of the plurality of cells is missing data or has corrupted data; and performing, by a machine learning (ML) model, a denoising process that removes random noise from the one or more cells having the missing data or corrupted data to thereby impute data to the one or more cells having the missing data or the corrupted data, the imputed data approximating the missing data or approximating an expected value of the corrupted data before the corrupted data was corrupted.

Embodiment 2. The method as recited in embodiment 1, wherein the ML model is trained to perform the denoising process, the training comprising: accessing a second QUBO problem comprising a second matrix that includes a plurality of cells, adding random noise to one or of the plurality of cells; removing the random noise from the one or more of the plurality of cells; and determining a loss by comparing the one or more plurality of cells having the random noise to the one or more cells where the random noise has been removed

Embodiment 3. The method as recited in embodiments 1-2, wherein the denoising process includes using a guide function that is configured to constrain the denoising process according to one or more architecture parameters of a quantum annealer (QA) that will solve the QUBO problem and one or more features of the QUBO problem.

Embodiment 4. The method as recited in any of embodiments 1-3, wherein the one or more architecture parameters of the QA include one or more of QA topology, number of qubits, and quality of the qubits.

Embodiment 5. The method as recited in any of embodiments 1-4, wherein the one or more features of the QUBO problem include one or more of QUBO size, QUBO problem difficulty, QUBO coefficient interdependency, QUBO variable connectivity, and number of variables or qubits.

Embodiment 6. The method as recited in any of embodiments 1-5, wherein the ML model is a Denoising Diffusion Probabilistic Model (DDPM).

Embodiment 7. The method as recited in any of embodiments 1-6, wherein the data in the plurality of cells is scaled to a predetermined interval before being subjected to the denoising process.

Embodiment 8. The method as recited in any of embodiments 1-7, wherein data in the plurality of cells that is outside of the predetermined interval is considered to be corrupted data.

Embodiment 9. The method as recited in any of embodiments 1-8, wherein the random noise is added to the one or more of the plurality of cells having the missing data or having the corrupted data by a computing system that hosts the ML model prior to the denoising process.

Embodiment 10. The method as recited in any of embodiments 1-9, wherein the added random noise has a value that is outside of an expected value of the missing data or the expected value of the corrupted data before the corrupted data was corrupted.

Embodiment 11. A method for performing any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-11.

### E. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that are executed on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to conduct executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

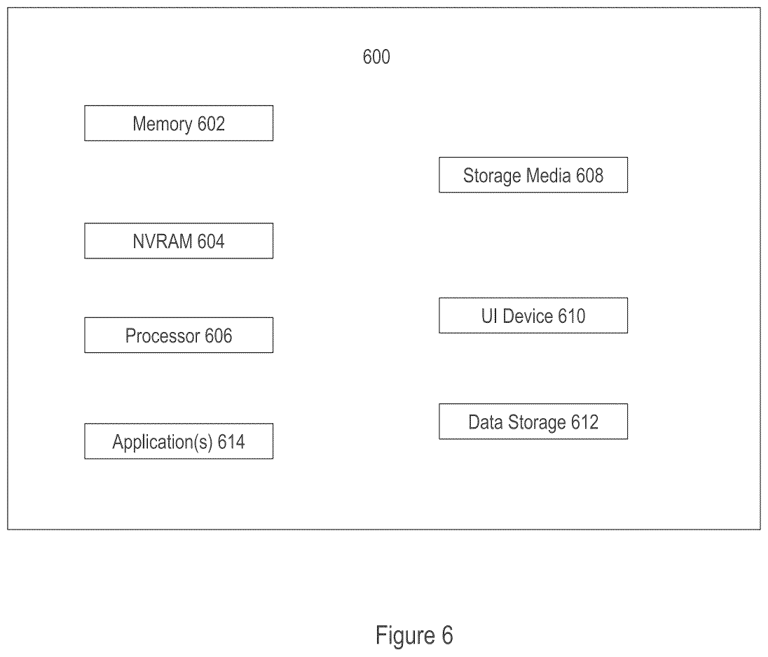

With reference briefly now to FIG. 6, any one or more of the entities disclosed, or implied, by any of the previously discussed figures, and/or elsewhere herein, may take the form of, or include, or be implemented on, or hosted by, a physical computing device, one example of which is denoted at 600. As well, where any of the aforementioned elements comprise or consist of a virtual machine (VM), that VM may constitute a virtualization of any combination of the physical components disclosed in FIG. 6.

In the example of FIG. 6, the physical computing device 600 includes a memory 602 which may include one, some, or all, of random access memory (RAM), non-volatile memory (NVM) 604 such as NVRAM for example, read-only memory (ROM), and persistent memory, one or more hardware processors 606, non-transitory storage media 608, UI device 610, and data storage 612. One or more of the memory components 602 of the physical computing device 600 may take the form of solid state device (SSD) storage. As well, one or more applications 614 may be provided that comprise instructions executable by one or more hardware processors 606 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving a Quadratic Unconstrained Binary Optimization (QUBO) problem, the QUBO problem comprising a matrix that includes a plurality of cells having data;
determining that one or more of the plurality of cells is missing data or has corrupted data; and
performing, by a machine learning (ML) model, a denoising process that removes random noise from the one or more cells having the missing data or corrupted data to thereby impute data to the one or more cells having the missing data or the corrupted data, the imputed data approximating the missing data or approximating an expected value of the corrupted data before the corrupted data was corrupted.

2. The method of claim 1, wherein the ML is trained to perform the denoising process, the training comprising:
accessing a second QUBO problem comprising a second matrix that includes a plurality of cells,
adding random noise to one or of the plurality of cells;
removing the random noise from the one or more of the plurality of cells; and
determining a loss by comparing the one or more plurality of cells having the random noise to the one or more cells where the random noise has been removed.

3. The method of claim 1, wherein the denoising process includes using a guide function that is configured to constrain the denoising process according to one or more architecture parameters of a quantum annealer (QA) that will solve the QUBO problem and one or more features of the QUBO problem.

4. The method of claim 3, wherein the one or more architecture parameters of the QA include one or more of QA topology, number of qubits, and quality of the qubits.

5. The method of claim 3, wherein the one or more features of the QUBO problem include one or more of QUBO size, QUBO problem difficulty, QUBO coefficient interdependency, QUBO variable connectivity, and number of variables or qubits.

6. The method of claim 1, wherein the ML model is a Denoising Diffusion Probabilistic Model (DDPM).

7. The method of claim 1, wherein the data in the plurality of cells is scaled to a predetermined interval before being subjected to the denoising process.

8. The method of claim 7, wherein data in the plurality of cells that is outside of the predetermined interval is considered to be corrupted data.

9. The method of claim 1, wherein the random noise is added to the one or more of the plurality of cells having the missing data or having the corrupted data by a computing system that hosts the ML model prior to the denoising process.

10. The method of claim 9, wherein the added random noise has a value that is outside of an expected value of the missing data or the expected value of the corrupted data before the corrupted data was corrupted.

11. A non-transitory storage medium having stored therein instructions that are executable by one or more hardware processors to perform operations comprising:
receiving a Quadratic Unconstrained Binary Optimization (QUBO) problem, the QUBO problem comprising a matrix that includes a plurality of cells having data;
determining that one or more of the plurality of cells is missing data or has corrupted data; and
performing, by a machine learning (ML) model, a denoising process that removes random noise from the one or more cells having the missing data or corrupted data to thereby impute data to the one or more cells having the missing data or the corrupted data, the imputed data approximating the missing data or approximating an expected value of the corrupted data before the corrupted data was corrupted.

12. The non-transitory storage medium as recited in claim 11, wherein the ML model is trained to perform the denoising process, the training comprising:
accessing a second QUBO problem comprising a second matrix that includes a plurality of cells,
adding random noise to one or of the plurality of cells;
removing the random noise from the one or more of the plurality of cells; and
determining a loss by comparing the one or more plurality of cells having the random noise to the one or more cells where the random noise has been removed.

13. The non-transitory storage medium as recited in claim 11, wherein the denoising process includes using a guide function that is configured to constrain the denoising process according to one or more architecture parameters of a quantum annealer (QA) that will solve the QUBO problem and one or more features of the QUBO problem.

14. The non-transitory storage medium as recited in claim 13, wherein the one or more architecture parameters of the QA include one or more of QA topology, number of qubits, and quality of the qubits.

15. The non-transitory storage medium as recited in claim 13, wherein the one or more features of the QUBO problem include one or more of QUBO size, QUBO problem difficulty, QUBO coefficient interdependency, QUBO variable connectivity, and number of variables or qubits.

16. The non-transitory storage medium as recited in claim 11, wherein the ML model is a Denoising Diffusion Probabilistic Model (DDPM).

17. The non-transitory storage medium as recited in claim 11, wherein the data in the plurality of cells is scaled to a predetermined interval before being subjected to the denoising process.

18. The non-transitory storage medium as recited in claim 17, wherein data in the plurality of cells that is outside of the predetermined interval is considered to be corrupted data.

19. The non-transitory storage medium as recited in claim 11, wherein the random noise is added to the one or more of the plurality of cells having the missing data or having the corrupted data by a computing system that hosts the ML model prior to the denoising process.

20. The non-transitory storage medium as recited in claim 19, wherein the added random noise has a value that is outside of an expected value of the missing data or the expected value of the corrupted data before the corrupted data was corrupted.
